(19) United States
(12) Patent Application Publication
(10) Pub. No.: US 2024/0375120 A1
(43) Pub. Date: Nov. 14, 2024

(54) APPARATUS AND METHOD FOR PROCESSING OLD CONCRETE

(71) Applicants: thyssenkrupp Polysius GmbH, Beckum (DE); thyssenkrupp AG, Essen (DE)

(72) Inventors: Sergej RATZLAFF, Lippstadt (DE); Guido KACHE, Beckum (DE); Oliver MAIER, Muenster (DE); Nicolas PATO, Neckarsteinach (DE)

(73) Assignees: thyssenkrupp Polysius GmbH, Beckum (DE); thyssenkrupp AG, Essen (DE)

(21) Appl. No.: 18/688,721

(22) PCT Filed: Aug. 29, 2022
(86) PCT No.: PCT/EP2022/073876

§ 371 Date: Mar. 1, 2024

(30) Foreign Application Priority Data
Sep. 3, 2021 (BE) BE 2021/5691
Sep. 3, 2021 (DE) 10 2021 209 729.4

(51) Int. Cl. B03B 9/06

(52) U.S. Cl. CPC B03B 9/065

(57) ABSTRACT

The present disclosure relates to an apparatus and method for processing old concrete. The old concrete comprises cement rock and an aggregate, including sand and/or gravel. The method includes: grinding the old concrete in a grinding device; classifying the ground old concrete in a classifying device into at least two products of different grain fractions. The grinding is effected at a grinding pressure of less than 50 MPa. The apparatus includes a grinding device for grinding the old concrete, and a classifying device for classifying the ground old concrete into at least two products of different grain fractions. The grinding device is designed, and configured, in such a way that the grinding of the old concrete is effected at a grinding pressure of less than 50 MPa.

The invention relates to an apparatus and a method for processing old concrete.

When producing concrete, building sand or gravel is usually used as aggregate. The worldwide demand for building sand is already very high and constantly increasing. It is estimated that between 30 and 50 billion tons of sand and gravel are consumed per year worldwide. An alternative to building sand is recycled concrete, which is fed in comminuted form back to the concrete production process. Currently, the recycling strategy for old concrete is based on producing a low-grade aggregate, which is used, for example, for backfilling in road construction. EP 3 613 713 A1 discloses a method for producing an aggregate for concrete from old concrete. The old concrete is crushed and subsequently classified into different grain sizes.

Such recycled aggregate or aggregates have a higher porosity in comparison with natural aggregate, and accordingly also a higher water absorption and a lower bulk density. Here, the bulk density is heavily dependent on the moisture level, resulting in an altered set of problems for the concrete production in comparison with the natural aggregate. The actual effective water content, which is the decisive manipulated variable for further quality optimization of the concretes, has hitherto not been able to be adjusted in a targeted manner and represents a great unknown. Therefore, recycled aggregates are to some extent assessed as inferior to natural aggregates.

Low-grade aggregates entail an increased water demand in the concrete application, the curing behavior of the thus produced concrete being worse than with natural aggregates. The grain size distribution, porosity and the grain shape of the concrete aggregate have a considerable influence on the processing properties and strength of the concrete.

Proceeding therefrom, it is the object of the present invention to specify an apparatus and a method for processing old concrete, wherein the quality of the aggregates recovered from the processed old concrete is improved.

This object is achieved according to the invention by means of a method having the features of independent method claim 1 and by means of an apparatus having the features of independent apparatus claim 11. Advantageous developments will become apparent from the dependent claims.

According to a first aspect, a method for processing old concrete, wherein the old concrete comprises cement rock and an aggregate, in particular sand and/or gravel, comprises:

grinding the old concrete in a grinding device and classifying the ground old concrete in a classifying device into at least two products of different grain fractions, wherein the grinding is effected at a grinding pressure of less than 50 MPa.

Optionally, the old concrete is pre-comminuted in a comminuting device prior to the grinding. The comminuting device is for example a crusher or a mill. The grain size of the optionally pre-comminuted old concrete discharged into the grinding device is, for example, 50 mm to 100 mm.

Old concrete should be understood to mean already hardened, solid concrete, which is obtained for example from the demolition of buildings. Old concrete comprises, in particular, a cement rock proportion, cement set with water and a proportion of preferably natural sand or gravel, which was used as aggregate in the production of the concrete.

The grinding device is for example a roller mill. A roller mill preferably comprises a first grinding roller and a second grinding roller, which are arranged opposite one another and can be driven in opposite directions, wherein a grinding gap is formed between the grinding rollers. The roller mill is preferably a high-pressure roller press, wherein the grinding material is comminuted largely or completely by pressure. It is also conceivable that a shear stress may additionally be generated in the grinding gap from the pressure. The material is comminuted by impact stress only to a negligible extent, if at all. The grinding pressure can preferably be adjusted in the grinding device. The grinding pressure should be understood to mean the pressure acting on the grinding material to be comminuted in the grinding gap. By way of example, this is generated and adjusted by means of a hydraulic pressing device on one of the grinding rollers.

A grinding pressure of less than 50 MPa ensures an operation of comminuting the old concrete in which only the cement rock connecting the grains of the aggregate is comminuted, and not the grains of the aggregate. A shear stress generates friction on the grain surface and a targeted abrasion of the cement rock from the aggregate. The sand and the gravel in the old concrete thus remain unchanged and the grain shape is optimally not destroyed.

According to a first embodiment, the grinding is effected at a grinding pressure which is lower than the fracture limit of the aggregate of the old concrete. The pressure acting on the old concrete is thus lower than the fracture limit of the aggregate, such as sand and gravel. This ensures that only the cement rock, which preferably has a lower fracture limit than the aggregate, is comminuted by means of the grinding device. The fracture limit of the aggregate should in particular be understood to mean the average fracture strength of the aggregate, such as sand and/or gravel, at which the aggregate is comminuted, in particular by pressure. The compressive strength of the old concrete should preferably be understood to mean the average compressive strength of the old concrete at which the old concrete is comminuted, in particular by pressure.

By way of example, the grinding device is connected to an open-loop/closed-loop control device which is designed in such a way that it controls the grinding pressure of the grinding device to a value of less than 50 MPa in open-loop/closed-loop fashion. By way of example, before being discharged into the grinding device, the old concrete is analyzed with regard to the properties of the aggregate composed of sand and/or gravel. Preferably, the fracture limit of the aggregate of the old concrete and/or the compressive strength of the old concrete are/is ascertained and transmitted to the open-loop/closed-loop control device. The open-loop/closed-loop control device is preferably designed in such a way that it controls the grinding pressure of the grinding device in open-loop/closed-loop fashion in dependence on the fracture strength of the aggregate and/or the compressive strength of the old concrete.

Preferably, the grinding pressure of the grinding device is adjusted in such a way that it is lower than the fracture strength of the aggregate and in particular higher than the compressive strength of the old concrete. What is achieved thereby is that the cement rock of the old concrete, said cement rock connecting the grains of the aggregate to one another, is crushed and the aggregate is simultaneously not damaged. The aggregate is preferably separated from the cement rock.

The grinding pressure is preferably adjusted in such a way that it is approximately 2 to 10 MPa, in particular 5 MPa, below the fracture limit of the aggregate.

An open-loop/closed-loop control device should be understood to mean a device designed for open-loop control and/or for closed-loop control.

The grinding device comprises a roller mill having two grinding rollers which form, between one another, a grinding gap, the grinding of the old concrete being effected with different rotational speeds of the grinding rollers in relation to one another. This produces a shear gradient, so as to create friction on the surface of the aggregate and to thus bring about a targeted abrasion of the cement rock from the grains of the aggregate.

According to a further embodiment, the grain size distribution of the ground old concrete is ascertained and the grinding pressure of the grinding device is controlled in open-loop/closed-loop fashion in dependence on the ascertained grain size distribution. The grain size distribution of the old concrete is ascertained for example by means of a visual inspection, for example in situ or online, wherein for example the quantities of old concrete are examined on different screen sizes.

A measuring device for ascertaining the grain size distribution of the ground old concrete is preferably arranged between the grinding device and the classifying device. The measuring device is preferably connected to the open-loop/closed-loop control device, wherein the grinding pressure is controlled in open-loop/closed-loop fashion in dependence on the ascertained grain size distribution.

By way of example, the ascertained grain size distribution is compared with a predetermined limit value or limit range and the grinding pressure is increased or reduced in the case of a deviation from the limit value or limit range. Preferably, the grinding pressure is increased if the ascertained grain size distribution exceeds the predetermined limit value or limit range. Preferably, the grinding pressure is reduced if the ascertained grain size distribution falls below the predetermined limit value or limit range.

According to a further embodiment, the grain size distribution is ascertained by means of an optical measuring device. An optical measuring device is for example a camera which is arranged in such a way that it can capture the grain sizes of the ground old concrete and transmit them for example to an image evaluation system. By way of example, the measuring device is arranged above a screen and captures the grain sizes lying on the screen. The grain size ascertained by the camera, in particular the image evaluation system, is transmitted to the open-loop/closed-loop control device.

The ground old concrete is classified in the classifying device into at least two products of different grain fractions, wherein the first product has a grain fraction with a grain size of 2 mm to 31.5 mm, in particular 2 mm to 16 mm, preferably 4 mm to 16 mm, and the second product has a grain fraction with a grain size of 0.15 mm to 2 mm, in particular 0.15 mm to 4 mm. The products are preferably used as aggregate in a subsequent process for producing concrete. For this purpose, the products may be fed to a further classifying device, in order to for example generate grain fractions which meet requirements according to DIN EN 12620.

By way of example, the ground old concrete is furthermore classified in the classifying device into a third product of a grain fraction with a grain size of smaller than 0.15 mm. The third product, in which in particular the cement rock is accumulated, is preferably subsequently used in a process for producing cement, in particular calcined to form cement clinker, wherein the cement rock is reactivated.

According to a further embodiment, the classifying of the ground old concrete comprises the screening of the ground old concrete in a screening device and/or the sifting of at least a portion of the ground or screened old concrete in a sifting device.

The classifying device preferably comprises a screening device and/or a sifting device. The sifting device is preferably positioned downstream of the screening device. This allows the ground old concrete to be classified in multiple steps, such that different grain fractions are reliably generated.

According to a further embodiment, the screening device comprises at least two screens, wherein the ground old concrete is classified into at least three different grain fractions. The screening device preferably comprises at least two, preferably three, four or more screens. In particular, the screens are arranged in series one behind the other and have different aperture sizes. To this end, the screens of a screening device are preferably arranged one above the other, such that the material flows by gravity through the screens. Preferably, the ground old 20 concrete is screened in the screening device into a first grain fraction with a grain size of 2 mm to 16 mm, in particular 4 mm to 16 mm, into a second grain fraction with a grain size greater than 16 mm and into a third grain fraction with a grain size of smaller than 2 mm, in particular smaller than 4 mm. The second grain fraction is preferably fed to the grinding device and reground. In particular, the quantity of material of the second grain fraction is ascertained by means of a measuring device and transmitted to the open-loop/closed-loop control device. Preferably, the grinding pressure of the grinding device is controlled in open-loop/closed-loop fashion in dependence on the ascertained quantity of the second grain fraction. By way of example, the ascertained quantity is compared with a predetermined limit value or limit range and the grinding pressure is increased or reduced in the case of a deviation of the quantity from the limit value or limit range. In particular, the grinding pressure is increased if the ascertained quantity exceeds the limit value or limit range. In particular, the grinding pressure is reduced if the ascertained quantity falls below the limit value or limit range.

Preferably, the material of the third grain fraction with a grain size of smaller than 2 mm, in particular smaller than 4 mm, screened in the screening device is fed to the sifting device.

According to a further embodiment, the screened old concrete is classified in the sifting device into a first grain fraction with a grain size of 0.15 mm to 2 mm, in particular 0.15 mm to 4 mm, and into a second grain fraction with a grain size smaller than 0.15 mm. The sifting device comprises, for example, a dynamic and/or a static sifter. A dynamic sifter comprises, for example, a rotatable rod cage, wherein the grains exceeding a certain grain size are rejected at the outer periphery of the rotating rod cage and exit the dynamic sifter through a course-material outlet, wherein the grains entering the rod cage exit the dynamic sifter through a fine-material outlet.

In a static sifter, coarse material sifting is preferably effected by way of impact and guiding devices. Parameters which influence the separating behavior of the static sifter include, for example, the design of the flow elements, in particular the angle of incidence of the guide blades of the flow elements and the flow speed, and the number of flow elements in the static sifter.

According to a further embodiment, the screened old concrete is classified in the sifting device into a first grain fraction with a grain size of 0.15 mm to 2 mm, in particular 0.15 mm to 4 mm, and into a second grain fraction with a grain size smaller than 0.15 mm.

According to a further embodiment, the classified, in particular screened and/or sifted old concrete of a grain fraction with a grain size of 0.15 mm to 16 mm, in particular 0.15 mm to 4 mm or 2 mm to 16 mm or 4 mm to 16 mm, is fed to a jig machine and separated in dependence on the density of the grains of the old concrete. Preferably, old concrete of a grain fraction with a grain size of 2 mm to 4 mm, 4 mm to 8 mm or 8 mm to 16 mm is fed to the jig machine.

The jig machine is preferably designed in such a way that it separates the material, in particular the ground old concrete, in dependence on the solids density of the grains. Preferably, grains as of a certain predetermined density limit value are separated from the grains having a density below the density limit value. The density limit value can preferably be adjusted in the jig machine. By way of example, the density limit value is approximately 2000 kg/m³ to 2800 kg/m³, in particular approximately 2500 kg/m³.

The apparatus for processing old concrete preferably comprises a first jig machine positioned downstream of the screening device. In particular, the first jig machine is connected to the screening device in such a way that it is fed with the screened old concrete of the grain fraction with a grain size of 2 mm to 16 mm, in particular 4 mm to 16 mm. The old concrete having a density above the predetermined density limit value is preferably fed to the first product, wherein preferably the old concrete having a density below the predetermined density limit value is fed to the grinding device for re-comminution.

Furthermore, the apparatus for processing old concrete comprises, for example, a second jig machine positioned downstream of the sifting device. In particular, the second jig machine is connected to the sifting device in such a way that it is fed with the sifted old concrete of the first grain fraction with a grain size of 0.15 mm to 2 mm, in particular 0.15 mm to 4 mm. The old concrete having a density above a predetermined density limit value is preferably fed to the second product, wherein the old concrete having a density below the predetermined density limit value is fed to the grinding device for re-comminution. The exhaust air from the jig machines is preferably fed to a dust removal device and dust is removed. Separation of the grains of the old concrete according to the solids density enables an increase in the quality of the product. The cement rock has a lower density than the aggregate, such as sand and gravel, and therefore grains containing a large proportion of cement rock are recirculated to the grinding device for re-comminution and the grains having a high proportion of sand and gravel form the product. In particular, the first product and the second product are used as aggregate in a concrete production process.

According to a further embodiment, the exhaust air from the screening device, the grinding device, the jig machine and/or the sifting device is fed to a dust removal device. The dust separated from the air in the dust removal device is preferably fed to the product with a grain size of smaller than 0.15 mm. This product is preferably mainly ground cement rock. The product is preferably fed to a cement production process.

The invention also relates to an apparatus for processing old concrete, comprising optionally a comminuting device for pre-comminution of the old concrete, a grinding device for grinding the old concrete, a classifying device for classifying the ground old concrete into at least two products of different grain fractions, wherein the grinding device is designed, and configured, in such a way that the grinding of the old concrete is effected at a grinding pressure of less than 50 MPa.

The above-described embodiments and advantages of the method for processing old concrete are also applicable in apparatus terms to the apparatus for processing old concrete.

The grinding device comprises a roller mill having two grinding rollers which form, between one another, a grinding gap, the grinding of the old concrete being effected with different rotational speeds of the grinding rollers in relation to one another. Preferably, the grinding device is designed, and configured, in such a way that the grinding rollers can be rotated at rotational speeds that differ from one another. In particular, a control device is provided, which is connected to the grinding device and is designed, and configured, to control the rotational speed of the grinding rollers such that they have rotational speeds that differ from one another.

According to one embodiment, the apparatus comprises a measuring device for ascertaining the grain size distribution of the ground old concrete and an open-loop/closed-loop control device which is connected to the grinding device and to the measuring device and is designed in such a way that it controls the grinding pressure of the grinding device in open-loop/closed-loop fashion in dependence on the ascertained grain size distribution.

According to a further embodiment, the classifying device comprises a screening device for screening the ground old concrete into at least two grain fractions and a sifting device for sifting at least a portion of the old concrete screened in the screening device.

According to a further embodiment, the screening device comprises at least two screens and is designed in such a way that it classifies the ground old concrete into at least three different grain fractions. According to a further embodiment, the screening device is connected to the sifter in such a way that the old concrete with a grain size smaller than 2 mm, in particular smaller than 4 mm, is fed to the sifting device. Preferably, only old concrete with a grain size smaller than 2 mm, in particular smaller than 4 mm, is supplied from the screening device to the sifting device.

The screening device is in particular connected to the sifting device in such a way that the old concrete with a grain size smaller than 2 mm, in particular smaller than 4 mm, is fed to the sifting device. The sifting device is preferably designed in such a way that it classifies the screened old concrete into a first grain fraction with a grain size of 0.15 mm to 2 mm, in particular 0.15 mm to 4 mm, and into a second grain fraction with a grain size smaller than 0.15 mm.

According to a further embodiment, the apparatus comprises at least one jig machine which is connected to the screening device and/or to the sifting device in such a way that the old concrete with a grain size of 0.15 mm to 2 mm to 4 mm or of 2 mm to 16 mm is fed to the jig machine.

According to a further embodiment, the apparatus for processing old concrete comprises a dust removal device which is connected to the sifting device, to the grinding device, to the jig machine and/or to the screening device, such that the exhaust air from the screening device, the grinding device, the jig machine and/or the sifting device is fed to the dust removal device.

### DESCRIPTION OF THE DRAWINGS

The invention is explained in more detail below on the basis of multiple exemplary embodiments with reference to the appended figures.

FIG. 1 shows a flow diagram of a method and of an apparatus for processing old concrete according to one exemplary embodiment.

FIG. 2 shows a flow diagram of a method and of an apparatus for processing old concrete according to a further exemplary embodiment.

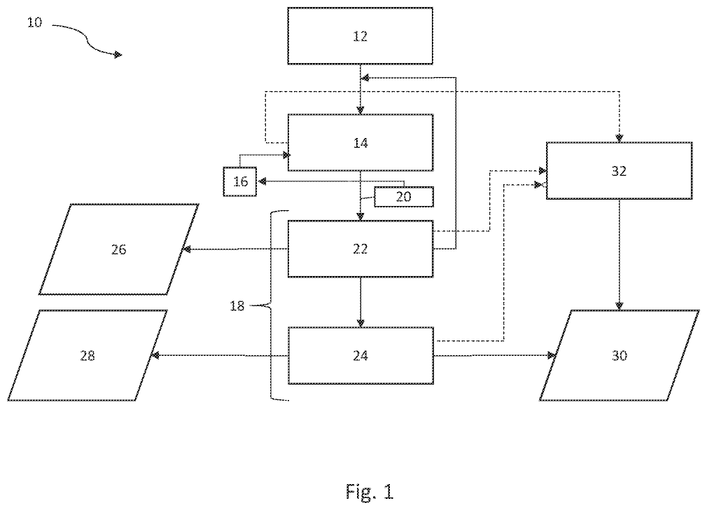

FIG. 1 shows a schematic illustration of an apparatus 10 for processing old concrete. FIG. 1 can also be read as a flow diagram of a method for processing old concrete. The old concrete is for example demolition concrete from buildings, wherein the old concrete preferably comprises an aggregate, such as sand and/or gravel, and cement rock. Cement rock should be understood to mean cement cured with water, which preferably connects the grains of the aggregate to one another. The processing of old concrete should be understood to mean processing of the old concrete such that it can at least partially be used as aggregate for producing concrete.

The apparatus 10 for processing old concrete according to the exemplary embodiment in FIG. 1 optionally comprises a comminuting device 12 for pre-comminution of the old concrete, for example a crusher or a mill. The comminuting device 12 is preferably designed, and configured, in such a way that it comminutes the old concrete to a grain size of approximately 50 mm to 100 mm. It is also possible for the old concrete to have already been comminuted to the aforementioned grain size during the demolition of a building, such that the comminuting device 12 is only optionally comprised in the apparatus 10.

The comminuting device 12 is adjoined in a material flow direction of the old concrete by a grinding device 14, in which the optionally pre-comminuted old concrete is ground. The grinding device 14 is preferably a roller mill. The grinding device preferably comprises two parallel grinding rollers which can be rotated in opposite directions and form, between them, a grinding gap. The old concrete is preferably comminuted in the grinding gap by means of the grinding pressure. The grinding pressure exerted on the old concrete in the grinding gap by the grinding rollers can preferably be adjusted in the grinding device 14. The old concrete is preferably ground at a grinding pressure of less than 50 MPa in the grinding device 14. Preferably, the grinding device is connected to an open-loop/closed-loop control device 16 which is designed in such a way that it controls the grinding pressure of the grinding device to a value of less than 50 MPa in open-loop/closed-loop fashion. By way of example, before being discharged into the grinding device, the old concrete is analyzed with regard to the properties of the aggregate composed of sand and/or gravel. Preferably, the fracture limit of the aggregate of the old concrete and/or the compressive strength of the old concrete are/is ascertained and transmitted to the open-loop/closed-loop control device. The open-loop/closed-loop control device 16 is preferably designed in such a way that it controls the grinding pressure of the grinding device 14 in open-loop/closed-loop fashion in dependence on the fracture strength of the aggregate and/or the compressive strength of the old concrete.

The fracture limit of the aggregate should in particular be understood to mean the average fracture strength of the aggregate, such as sand and/or gravel, at which the aggregate is comminuted, in particular by pressure. The compressive strength of the old concrete should preferably be understood to mean the average compressive strength of the old concrete at which the old concrete is comminuted, in particular by pressure.

Preferably, the grinding pressure of the grinding device 14 is adjusted in such a way that it is lower than the fracture strength of the aggregate and in particular higher than the compressive strength of the old concrete. What is achieved thereby is that the cement rock of the old concrete, said cement rock connecting the grains of the aggregate to one another, is crushed and the aggregate is simultaneously not damaged. The aggregate is preferably separated from the cement rock.

The grinding pressure is preferably adjusted in such a way that it is approximately 2 to 10 MPa, in particular 5 MPa, below the fracture limit of the aggregate.

The grinding device 14 is preferably adjoined in the material flow direction of the ground old concrete by a classifying device 18, in which the ground old concrete is classified into at least two products of different grain size distribution. Preferably, the ground old concrete is classified into three products of different grain size. Preferably, the ground old concrete is classified into a first product with a grain size of, for example, 2 mm to 16 mm, in particular 4 mm to 16 mm, and a second product with a grain size of, for example, 0.15 mm to 2 mm, in particular 0.15 mm to 4 mm. In particular, the old concrete is additionally classified into a third product with a grain size of smaller than 0.15 mm.

A measuring device 20 for ascertaining the grain size distribution of the ground old concrete is preferably arranged between the grinding device 14 and the classifying device 18. The measuring device 20 is preferably connected to the open-loop/closed-loop control device 16, wherein the grinding pressure is controlled in open-loop/closed-loop fashion in dependence on the ascertained grain size distribution.

By way of example, the ascertained grain size distribution is compared with a predetermined limit value or limit range and the grinding pressure is increased or reduced in the case of a deviation from the limit value or limit range. Preferably, the grinding pressure is increased if the ascertained grain size distribution exceeds the predetermined limit value or limit range.

Preferably, the grinding pressure is reduced if the ascertained grain size distribution falls below the predetermined limit value or limit range.

The classifying device 18 preferably comprises a screening device 22 and/or a sifting device 24. By way of example, in the exemplary embodiment in FIG. 1 the sifting device 24 is positioned downstream of the screening device 22. The screening device 22 preferably comprises at least two, preferably three, four or more screens. In particular, the screens are arranged in series one behind the other and have different aperture sizes. Preferably, the ground old concrete is screened in the screening device 22 into a first grain fraction with a grain size of, for example, 2 mm to 16 mm, in particular or 4 mm to 16 mm, into a second grain fraction with a grain size greater than 16 mm and into a third grain fraction with a grain size of, for example, smaller than 2 mm, in particular smaller than 4 mm. The second grain fraction is preferably fed to the grinding device 14 and reground. In particular, the quantity of material of the second grain fraction is ascertained by means of a measuring device and transmitted to the open-loop/closed-loop control device. Preferably, the grinding pressure of the grinding device is controlled in open-loop/closed-loop fashion in dependence on the ascertained quantity of the second grain fraction. By way of example, the ascertained quantity is compared with a predetermined limit value or limit range and the grinding pressure is increased or reduced in the case of a deviation of the quantity from the limit value or limit range. In particular, the grinding pressure is increased if the ascertained quantity exceeds the limit value or limit range. In particular, the grinding pressure is reduced if the ascertained quantity falls below the limit value or limit range.

Preferably, the material of the third grain fraction with a grain size of, for example, smaller than 2 mm, in particular smaller than 4 mm, screened in the screening device 22 is fed to the sifting device 24. The sifting device 24 is for example a dynamic sifter with a rotatable rod cage. A dynamic sifter additionally comprises, for example, a fan for generating the sifting air and a filter or cyclone for separating the fine material from the air volume flow. In the sifting device 24, the screened old concrete is preferably classified into a first grain fraction with a grain size of, for example, 0.15 mm to 2 mm, in particular or 0.15 mm to 4 mm, and into a second grain fraction with a grain size smaller than 0.15 mm.

In particular, the material of the grain fraction with a grain size of 2 mm to 16 mm, in particular 4 mm to 16 mm, screened in the screening device 22 forms the first product 26. Preferably, the material of the grain fraction with a grain size of, for example, 0.15 mm to 2 mm, in particular 0.15 mm to 4 mm, classified in the sifting device 24 forms the second product 28. The material of the grain fraction with a grain size of smaller than 0.15 mm classified in the sifting device 24 preferably forms the third product 30.

The exhaust air from the sifting device 24, the screening device 22 and/or the grinding device 14 is preferably fed to a dust removal device 32 for dust removal, wherein the dust separated off in the dust removal device 32 is preferably fed to the third product 30.

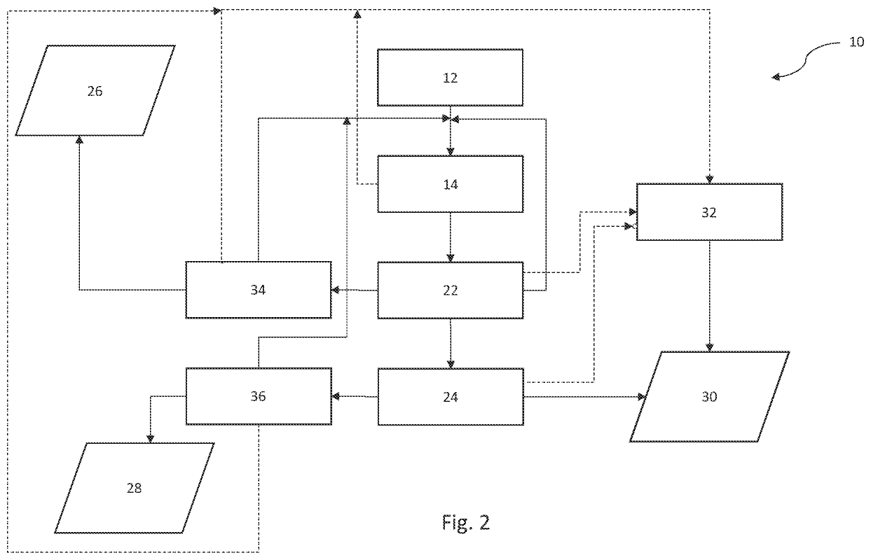

FIG. 2 shows a schematic illustration of an apparatus 10 for processing old concrete which largely corresponds to the apparatus in FIG. 1, identical elements being denoted by identical reference signs. FIG. 2 can also be read as a flow diagram of a method for processing old concrete. The apparatus 10 in FIG. 2 also comprises a measuring device 20 and an open-loop/closed-loop control device 16 as per FIG. 1, which are not illustrated in FIG. 2 for the sake of clarity.

In contrast to FIG. 1, FIG. 2 additionally comprises two jig machines 34, 36 which are by way of example positioned downstream of the screening device 22 and of the sifting device 24, respectively. It is also conceivable for the apparatus 10 to comprise only one jig machine 34, 36 which is positioned downstream of the screening device 22 and/or of the sifting device 24. The jig machine 34, 36 is preferably designed in such a way that it sorts the material, in particular the ground old concrete, according to its solids density. Preferably, grains as of a certain predetermined density limit value are separated from the grains having a density below the density limit value. The density limit value can preferably be adjusted. By way of example, the density limit value is approximately 2000 kg/m³ to 2800 kg/m³, in particular approximately 2500 kg/m³.

The apparatus 10 preferably comprises a first jig machine 34 positioned downstream of the screening device 22. In particular, the first jig machine 34 is connected to the screening device 22 in such a way that it is fed with the screened old concrete of the first grain fraction with a grain size of, for example, 2 mm to 16 mm, in particular 4 mm to 16 mm. The old concrete having a density above the predetermined density limit value is preferably fed to the first product 26, wherein the old concrete having a density below the predetermined density limit value is fed to the grinding device 14 for re-comminution.

Furthermore, the apparatus 10 comprises, for example, a second jig machine 36 positioned downstream of the sifting device 24. In particular, the second jig machine 36 is connected to the sifting device 24 in such a way that it is fed with the sifted old concrete of the first grain fraction with a grain size of, for example, 0.15 mm to 2 mm, in particular 0.15 mm to 4 mm. The old concrete having a density above a predetermined density limit value is preferably fed to the second product 28, wherein the old concrete having a density below the predetermined density limit value is fed to the grinding device 14 for re-comminution. The exhaust air from the jig machines 34, 36 is preferably fed to the dust removal device 32 and dust is removed.

Classification of the old concrete according to the solids density enables the production of a higher-quality product 26, 28. The cement rock has a lower density than the aggregate, such as sand and gravel, and therefore grains containing a large proportion of cement rock are recirculated to the grinding device 14 for re-comminution and the grains having a high proportion of sand and gravel form the product 26, 28. In particular, the first product 26 and the second product 28 are used as aggregate in a concrete production process.

### LIST OF REFERENCE SIGNS

10 Apparatus for processing old concrete
12 Comminuting device
14 Grinding device
16 Open-loop/closed-loop control device
18 Classifying device
20 Measuring device
22 Screening device
24 Sifting device
26 First product
28 Second product
30 Third product
32 Dust removal device
34 Jig machine
36 Jig machine

1. A method for processing old concrete, wherein the old concrete comprises cement rock and an aggregate, including at least one of sand and gravel, the method comprising:
grinding the old concrete in a grinding device, and
classifying the ground old concrete in a classifying device into at least two products of different grain fractions,
wherein the grinding is effected at a grinding pressure of less than 50 MPa, and wherein the grinding device comprises a roller mill having two grinding rollers which form, between one another, a grinding gap, and wherein the grinding of the old concrete is effected with different rotational speeds of the grinding rollers in relation to one another.

2. The method as claimed in claim 1, wherein the grinding is effected at a grinding pressure which is lower than the fracture limit of the aggregate of the old concrete.

3. The method as claimed in claim 2, wherein the grain size distribution of the ground old concrete is ascertained and the grinding pressure of the grinding device is controlled in open-loop/closed-loop fashion in dependence on the ascertained grain size distribution.

4. The method as claimed in claim 3, wherein the grain size distribution is ascertained by means of an optical measuring device.

5. The method as claimed in claim 4, wherein the ground old concrete is classified in the classifying device into at least two products of different grain fractions, wherein the first product has a grain fraction with a grain size of 4 mm to 16 mm, and the second product has a grain fraction with a grain size of 0.15 mm to 4 mm.

6. The method as claimed in claim 3, wherein the classifying of the ground old concrete comprises at least one of the screening of the ground old concrete in a screening device and/or the sifting of at least a portion of one of the ground and screened old concrete in a sifting device.

7. The method as claimed in claim 3, wherein the screening device comprises at least two screens and the ground old concrete is classified into at least three different grain fractions.

8. The method as claimed in claim 8, wherein the classified old concrete of a grain fraction with a grain size of 0.15 mm to 4 mm and 2 mm to 16 mm and 4 mm to 16 mm, is fed to a jig machine and the old concrete is classified in dependence on the density of the old concrete.

9. The method as claimed in claim 8, wherein the screened old concrete is classified in the sifting device into a first grain fraction with a grain size of 0.15 mm to 4 mm, and into a second grain fraction with a grain size smaller than 0.15 mm.

10. The method as claimed in claim 3, wherein the exhaust air from at least one of the screening device, the grinding device, the jig machine and/or the sifting device is fed to a dust removal device for removal of dust.

11. An apparatus for processing old concrete, comprising:
a grinding device for grinding the old concrete, and
a classifying device for classifying the ground old concrete into at least two products of different grain fractions,
wherein the grinding device is designed, and configured, in such a way that the grinding of the old concrete is effected at a grinding pressure of less than 50 MPa, and wherein the grinding device comprises a roller mill having two grinding rollers which form, between one another, a grinding gap, and wherein the grinding device is designed, and configured, in such a way that the grinding of the old concrete is effected with different rotational speeds of the grinding rollers in relation to one another.

12. The apparatus as claimed in claim 11, wherein the apparatus comprises a measuring device for ascertaining the grain size distribution of the ground old concrete and an open-loop/closed-loop control device which is connected to the grinding device and to the measuring device and is designed in such a way that it controls the grinding pressure of the grinding device in open-loop/closed-loop fashion in dependence on the ascertained grain size distribution.

13. The apparatus as claimed in claim 12, wherein the classifying device comprises at least one of a screening device for screening the ground old concrete into at least two grain fractions and/or a sifting device for sifting the old concrete into at least two grain fractions.

14. The apparatus as claimed in claim 13, wherein the screening device comprises at least two screens and is designed in such a way that it classifies the ground old concrete into at least three different grain fractions.

15. The apparatus as claimed in claim 14, wherein the apparatus comprises at least one jig machine which is connected to at least one of the screening device and/or to the sifting device in such a way that the old concrete with a grain size of one of 0.15 mm to 4 mm, or with a grain size of 4 mm to 16 mm, is fed to the jig machine.

16. The apparatus as claimed in claim 15, wherein the apparatus comprises a dust removal device which is connected to at least one of the classifying device, to the grinding device and/or to the jig machine, such that the exhaust air from one of the classifying device, the grinding device and/or the jig machine is fed to the dust removal device.
